(19) United States
(12) Patent Application Publication
(10) Pub. No.: US 2013/0083054 A1
(43) Pub. Date: Apr. 4, 2013

(54) SYSTEM AND METHOD FOR MANAGING HEALTH TREATMENT PLANS

(71) Applicant: WELLPOINT, INC., Chicago, IL (US)

(72) Inventor: Yousef Bayouk, Irvine, CA (US)

(73) Assignee: WELLPOINT, INC., Chicago, IL (US)

(21) Appl. No.: 13/623,218

(22) Filed: Sep. 20, 2012

Related U.S. Application Data
(60) Provisional application No. 61/537,175, filed on Sep. 21, 2011.

(51) Int. Cl. G09G 5/00

(52) U.S. Cl. CPC G09G 5/003
USPC 345/619

(57) ABSTRACT

Methods and systems for managing health treatment plans are described. Data describing a physical and/or mental status of an individual is received. A visual representation of the status is created. The visual representation is displayed to a representative of the individual. The representative interacts with the visual representation. Feedback data regarding the visual representation is received from the representative. The feedback data is communicated to the individual.

### CROSS REFERENCE TO RELATED APPLICATIONS

This application claims priority to U.S. Provisional Patent Application No. 61/537,175, filed Sep. 21, 2011, the entirety of which is incorporated herein by reference.

### FIELD OF THE INVENTION

The systems and methods described herein relate to managing health treatment plans.

### SUMMARY OF EMBODIMENTS OF THE INVENTION

The present invention is directed to systems, methods and computer-readable media for managing health treatment plans. Data describing a physical and/or mental status of an individual is received. A visual representation of the status is created. The visual representation is displayed to a representative of the individual (e.g., a healthcare services provider). The representative interacts with the visual representation. Feedback data regarding the visual representation is received from the representative. The feedback data is communicated to the individual.

### BRIEF DESCRIPTION OF THE DRAWINGS

FIG. 1 illustrates a system for use in accordance with an exemplary embodiment of the invention;

FIG. 2 illustrates a flow chart in accordance with an exemplary method of the invention;

FIG. 3 illustrates exemplary computer hardware and software systems that may be used in connection with the present invention; and

FIGS. 4A and 4E are exemplary screen displays that may be used in connection with the present invention.

### DETAILED DESCRIPTION

The systems and methods described herein leverage the use of an electronic, visual representation of an individual's physical and mental state that is accessible by interested parties in an electronic environment.

The representation of the individual's physical and mental state may be shown by way of a digital representation of a person, depicted using a dashboard and/or other visual methods. The visual representation may be created based on information contained in the individual's electronic medical record reflecting the individual's health and health status, any diseases he or she has, current treatments, including prescriptions, treating physicians and care team, past medical history, health habits, and genetic predispositions, by way of example. The visual representation may also be created and/or updated based on information such as that reported through a biometric device worn by the individual. Mental health status can be assessed and tracked, for example, via voice patterns, blood pressure readings, heart rate readings and serotonin levels obtained from the bio-metric device, depending on its capabilities. The information received from the electronic medical record (which may be historical, present, and/or predicted) and/or biometric device is used to reflect changes in the electronic representation associated with the individual and/or identify clinical information and/or disease states. The biometric device may be a sensor located in the building in which the individual is located (e.g., home or office) or the biometric device may be worn by the individual, following the individual wherever he goes. This allows the individual to have freedom to maintain his or her active lifestyle while still allowing the mechanism for health information to reach the central location for sharing across the health data exchange. The information can also be self-reported by the individual, e.g., by typing relevant information into a web page. In some embodiments, the visual representation is created by way of a self assessment initially and, as new information is received (e.g., based on care plans/treatment plans for the individual), the electronic representation is continually updated.

The electronic environment can be accessed by a provider, caregiver, medical facility, medical group, or health insurance plan representative (each, a “representative”) to identify health risks or otherwise monitor the individual's physical and mental state. The representative may then interact with the visual representation to understand more about the individual's physical and mental state, and how to treat or manage it, and communicate information regarding the same to the individual (or others associated with the individual such as caregivers, family members, or other healthcare providers) to alert the member of the risk, to indicate a new treatment plan, to indicate a change to an existing treatment plan, or otherwise convey messages regarding the individual's physical or mental state. This messaging may be accomplished by interacting with the electronic representation in the online environment, by sending a text or email message, or communicating in some other format.

Thus, the systems and methods described herein allow for active monitoring of an individual by a representative without requiring the individual to communicate proactively with the representative about his or her physical and mental status, as a treatment plan is followed or otherwise. This more effective means of communication between the representative and the individual via real-time updates and feedback results in improving the individual's quality of care, including avoidance of relapses. Providing representatives with increased opportunities to treat patients proactively and more effectively reduces costs and improves the healthcare system in which they operate.

As referred to above, in an exemplary embodiment, the individual's health and mental status can be tracked in at least two ways: active monitoring and passive monitoring.

Active monitoring may include, by way of example, communication regarding confirmation or denial of the individual's condition, information regarding compliance with a treatment regimen, and denial of association with the member/provider. Using the methods and systems described herein, this type of compliance tracking and two way communication between the individual and the representative are enhanced. The individual and representative can be in frequent (or constant) communication, thereby allowing the treatment plan to be continuously reviewed and commented on. The representative can thus provide real-time integration between the treatment plan and the individual's actual health status, thereby preventing any delay in needed testing, treatments or appointments. Also, as feedback regarding the individual's treatment is received, the representative has the ability to review the treatment plan and make adjustments if and as events warrant it. For example, as a patient is exposed to a new medication, and the provider is advised of any adverse reactions, negative outcomes or no improvement immediately through the system, the provider may then modify the medication to address the adverse event or negative outcome.

Passive monitoring may also be used in connection with the systems and methods described herein. For example, the representative may communicate with the individual informing the individual that he or she is eligible for a new treatment or procedure for which he or she has qualified (e.g., due to the individual reaching a certain age or upon the treatment being approved by the individual's insurance company).

The following provides implementation details for one exemplary embodiment of the present invention.

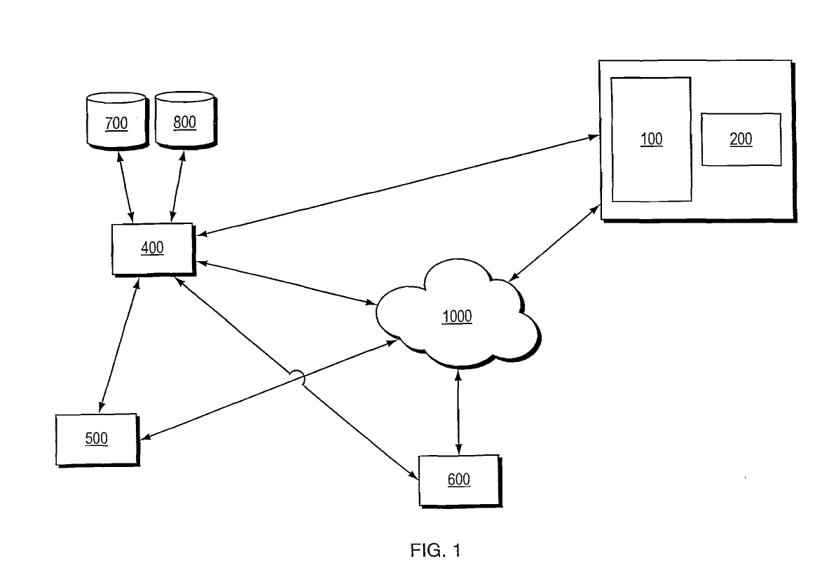

FIG. 1 is a diagram depicting an exemplary system in accordance with one embodiment of the invention. Individual 100 is a patient or other individual whose physical and/or mental status is being monitored. Representative 600 may be a health care provider(s) to individual 100 or an entity(ies) that is otherwise interested in the status of individual 100. Electronic medical records source 500 is a repository for and source of electronic medical record information for individual 100, which may be updated with information each time the individual has a doctor's visit, a test performed, fills a prescription etc. There may be multiple sources 500 of electronic medical records for any one or many individuals 100, although only one is shown in this embodiment. Also, as referred to above, individual 100 may self-report information about his physical and mental condition in the on-line environment.

Service provider 400 is responsible for creating and maintaining the on-line environment as described herein. Service provider 400 may be an insurer of individual 100, or other third party service provider who agrees to provide services on behalf of an entity that is interested in monitoring the status of individual 100. Sources of medical information in database(s) 700 (e.g., care guidelines, treatment protocols, diagnostic information, etc.) to assist provider in the treatment and care of individual 100 are made available to the provider in the electronic environment. Database(s) 800 may provide other types of medical information that allow for the visual representation of the individual's physical and/or mental state to be displayed in the online environment. Thus, for example, if the electronic medical record of the individual indicates that the individual has high blood pressure, a lookup may be performed in database(s) 800 to identify the icon or other visual representation that will convey to the representative 600 that the individual has high blood pressure.

In the exemplary embodiments described herein, individual 100 is a patient, representative 600 is a provider of health care to the patient, and service provider 400 is an insurance company that provides health care insurance coverage to the patient (or an entity acting on behalf of the insurance company). However, it will be understood by those skilled in the art that the identities of such entities may be otherwise, in accordance with the present invention.

Individual 100, electronic medical records source 500 and representative 600 may send and/or receive information to/from service provider 400 over an electronic communication network, such as the Internet 1000, including using wireless communication techniques. For example, such communications may be sent and received via a web site hosted by or on behalf of service provider 400. Other data may be sent to or received from service provider 400 by way of a direct file transfer (e.g., SFTP) and a batch file upload. The devices used by foregoing entities to communicate information to and from service provider 400 may include personal computers, or mobile devices, which would allow the entities the ability to track and report on the status of individual 100 when travelling or otherwise away from a personal computer. The displays on mobile devices may be formatted appropriately (e.g., condensed).

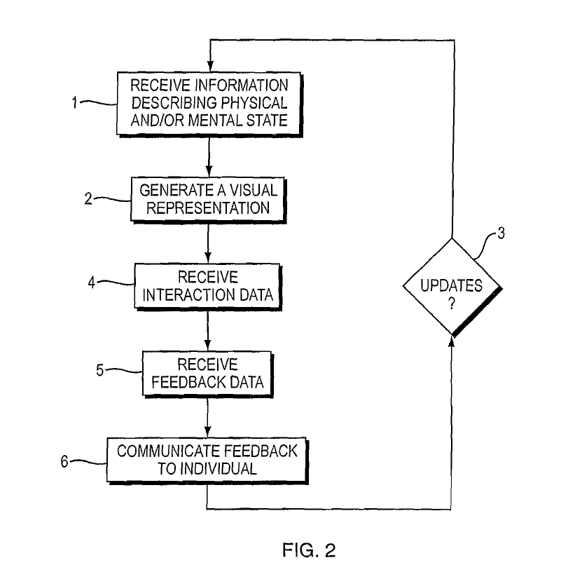

In step 1 of an exemplary method, described with reference to FIG. 2, service provider 400 receives information regarding the physical and mental status of individual 100. In one embodiment, this information is received from electronic medical records source(s) 500. Other information may come directly from individual 100 or representative(s) 600.

In step 2 of the exemplary method, the received information is used to generate a visual representation of the physical and/or mental status of individual 100. In one embodiment, the visual representation takes the form of a digital representation of a person. In other embodiments, a dashboard is created. The visual representation is, in the preferred embodiment, made available for viewing (by individual 100, representative 600, their designees, or other interested party) via a Web site page. One exemplary manner in which this can be accomplished involves identifying characteristics associated with the physical and/or mental status of the individual 100, and performing a look up in database 800 to identify the visual representation that should be displayed for a given characteristic. Thus, for example, a body temperature may be depicted using a thermometer, blood pressure may be depicted using a blood pressure cuff, lung functioning may be depicted using a face that indicates puffing cheeks or lungs, and cardiac condition may be depicted showing a heart.

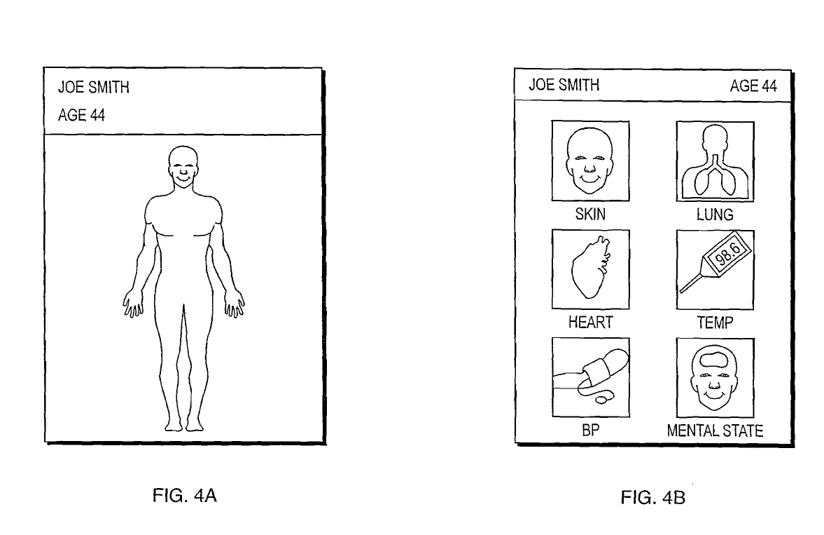

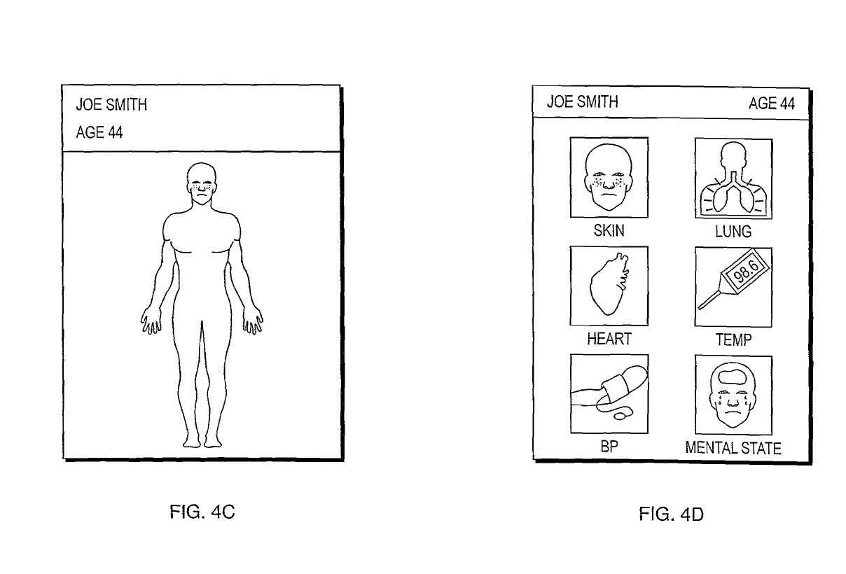

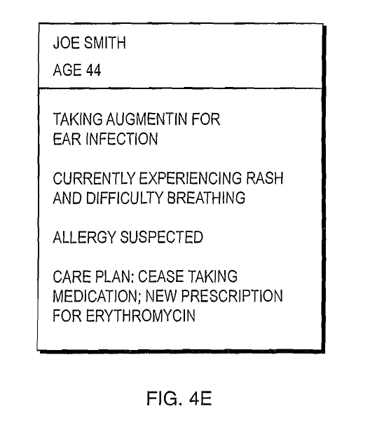

An exemplary digital representation of a person that may be displayed on a Web site page is shown in FIG. 4A. An exemplary dashboard that may be displayed on a Web site page is shown in FIG. 4B.

In step 3, service provider 400 may receive updates as to the physical and/or mental status of individual 100 in several ways. First, individual 100 may enter information regarding his physical and/or mental state, including information regarding his compliance with a treatment plan or other regime, using a Web site page hosted by or on behalf of service provider 400. Second, individual 100 may wear a biometric device 200, or be in proximity to some other form of monitoring device that monitors physical attributes of individual 100, which data may then be transmitted to service provider 400 electronically. As new electronic medical records are available at electronic medical records source 500 for individual 100, such information may be transmitted to service provider 400. This may be performed in accordance with a scheduled batch process, and/or at the request of, e.g., individual 100 or representative 600. Still further, representative 600 may transmit to service provider 400 updated information as to the physical and/or mental status of individual 100, e.g., using a Web site page hosted by or on behalf of service provider or by way of direct transmission.

As service provider 400 receives updates as to the status of the individual 100, the visual representation of the individual is updated, again using database(s) 800 which storing information regarding the manner in which a particular mental or physical condition should be indicated visually, reflecting any changed status. Thus, for example with reference to FIGS. 4C and 4D, the individual may begin to suffer symptoms (e.g., a rash may develop, difficulty breathing etc.) upon beginning to take a drug for the first time, and this is reflected in the visual representation.

Representative 600 may review the status of the individual 100 using the visual representation. This may be accomplished by the representative 600 logging on to the Web site hosted by or on behalf of service provider 400, either using a personal computer or a mobile device. In other circumstances, representative 600 may receive an email message, text message or other alert, indicating any change in status of individual 100, which may indicate whether the change in status is high, medium, or low, or, perhaps, only those changes in status that require immediate attention. These settings may be configurable by the representative 600 and, in some cases, the representative 600 may have their designee (e.g., a nurse or other care manager) receive and attend to the alert. The representative may then view the visual representation, e.g., as shown in FIGS. 4C and 4D.

In step 4, representative 600 interacts with the visual representation. In this instance, the representative may see the new symptoms being suffered by the patient. Representative 600 may click on, touch or otherwise interact with the visual representation depicting the symptoms. For example, the representative may touch the facial area showing the rash or puffing cheeks of FIG. 4C or the skin or lung icons of FIG. 4D. Upon doing so, medication information source 700 is consulted for information about the symptom or condition. In this example, knowing the individual is taking a particular medication (from the individual's medical record), and knowing the individual has developed a rash and is having trouble breathing, medical information source 700 is consulted and return results inform the provider that the individual is having an allergic reaction to his medication, the individual should stop taking the medication and, perhaps, suggest a new medication to be prescribed. An exemplary screen depicting the same is shown in FIG. 4E. Representative 600 may then provide feedback to the individual to cease taking the drug in question and may prescribe a different drug for the individual's condition, in step 5.

In step 6, the feedback is communicated back to the individual 100. This may occur by way of an email message, a text message, a posting on a website page that can be accessed by the individual, or through other means. As the individual acts on the feedback, any updates to the individual's physical and/or mental state are fed back into the system.

In another example, the visual representation of the individual may depict continually elevated blood pressure, despite the individual having made lifestyle changes to try to control his blood pressure. Upon seeing this indication in the visual representation, the provider may consult medical management rules (accessible to the provider in the electronic environment), and determine that the individual needs medication to control his blood pressure. The provider may send a message to the individual indicating he has called in a prescription for the individual or that the individual must schedule an appointment with the provider to discuss commencing a blood pressure medication regime.

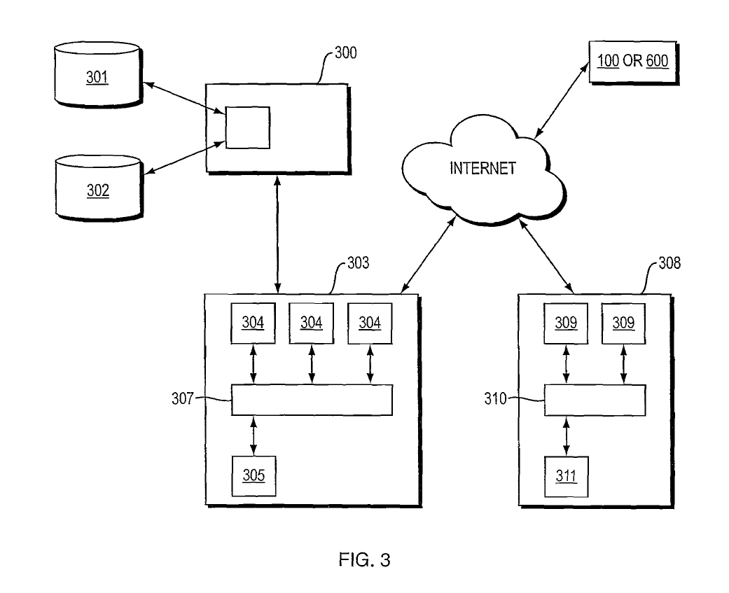

Exemplary hardware and software employed by the systems (e.g., electronic medical records source 500 and service provider 400) are now generally described with reference to FIG. 3. Database server(s) 300 may include a database services management application 306 that manages storage and retrieval of data from the database(s) 301, 302. The databases may be relational databases; however, other data organizational structure may be used without departing from the scope of the present invention. One or more application server(s) 303 are in communication with the database server 300. The application server 303 communicates requests for data to the database server 300. The database server 300 retrieves the requested data. The application server 303 may also send data to the database server for storage in the database(s) 301, 302. The application server 303 comprises one or more processors 304, computer readable storage media 305 that store programs (computer readable instructions) for execution by the processor(s), and an interface 307 between the processor(s) 304 and computer readable storage media 305. The application server may store the computer programs referred to herein.

To the extent data and information is communicated over the Internet, one or more Internet servers 308 may be employed. The Internet server 308 also comprises one or more processors 309, computer readable storage media 311 that store programs (computer readable instructions) for execution by the processor(s) 309, and an interface 310 between the processor(s) 309 and computer readable storage media 311. The Internet server 308 is employed to deliver content that can be accessed through the communications network, e.g., by individual 100 or representative 600. When data is requested through an application, such as an Internet browser, the Internet server 308 receives and processes the request. The Internet server 308 sends the data or application requested along with user interface instructions for displaying a user interface.

The computers referenced herein are specially programmed to perform the functionality described herein as performed by the software programs. The programs described herein are, in one embodiment, executed on the systems of service provider 400, of FIG. 1.

The non-transitory computer readable storage media may include volatile and non-volatile, removable and non-removable media implemented in any method or technology for storage of information such as computer-readable instructions, data structures, program modules, or other data. Computer readable storage media may include, but is not limited to, RAM, ROM, Erasable Programmable ROM (EPROM), Electrically Erasable Programmable ROM (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the computer system.

At least some embodiments of the systems and methods described herein provide a number of advantages, including the following.

For example, the systems and methods may allow for fraud, waste and abuse monitoring, which is a concern for the healthcare industry. In particular, it allows insurance companies to protect themselves from people who attempt to gouge the system and may reward those who take an active part in their health by following their provider's instructions. For example, individuals may have the ability to gain incentives with changes in their health status in certain embodiments. A direct link may be established between the improvements in individual's health status and insurance premium incentives.

It may also help with communication of information regarding individuals who may not understand or have the ability to follow their provider's instructions, or report events relating to their health status, due to cognitive impairment, physical impairment/limited mobility, or mental health status.

In addition, it facilitates medical management, by allowing the representative to validate whether an individual is in compliance with his treatment plan or communicate with the individual that he or she is off-track and needs to get back on the plan (or, possibly, face consequences such as increased premiums or stricter treatment plans).

Additionally, the systems and methods can be applied to any age group (or perhaps even to non-humans) for monitoring, from adolescents to senior citizens regardless of purpose, since the biometric device and health monitoring can be interchanged.

The technologies described herein can also be used in connection with verifying eligibility for member incentives upon verification of health status, without manual manipulation or interference and without use of potentially unreliable self-reporting of the member. For instance, an employer group may reward its employees for taking smoking cessation products or certifications. The employer could use the technologies described herein to monitor activity to detect when an individual may be smoking.

Clinical intervention program integration is also possible using the described technologies. Interventions and care alerts can be sent to the member via the on-line environment (or sent via an alert to the biometric device worn by the patient) instructing the patient to pick up their refill at the pharmacy; reminding the individual about an appointment; validating compliance of a treatment plan; following-up after being discharged from hospital; conducting a health risk assessment; providing a wellness check reminder; providing a flu shot reminder; sending information or alerts relating to smoking cessation; providing information regarding weight management and incentives; providing information regarding prenatal care and incentives; providing health education, nutrition, and fitness information; and providing information regarding the individual's health scorecard and any associated rewards.

The technologies described herein also allow for increased focus on the senior and Medicare population, by monitoring members who choose not to live in an assisted living facility or who may not have support at home. The systems and methods provide a mechanism to support these individuals without frequent calls by case managers or communication via standard channels, which do not provide the feedback needed to make a difference in quality of care.

State and federal governments could cost-effectively monitor participants in half way houses, nursing homes, children in foster homes or children who have recently been adopted using the technologies described herein. Prison systems can also monitor inmates who meet the criteria for clinical follow-up and who have entered into rehab programs once released or who are on parole.

New medical technologies allow many less seriously ill patients who previously would have received inpatient surgical care to receive care in outpatient settings. Patients, who in the past would have continued the early stages of their recovery in the hospital, today are discharged to skilled nursing facilities or to their home. With the use of the systems and methods described herein, the same quality of care can be incorporated across multiple virtual locations via monitoring of patients in their home which are linked to the central monitoring station. This creates a new paradigm in healthcare by allowing fewer medical resources to monitor a greater number of patients across any geographical location. This situation would be ideal for patients with minor health concerns that require minimal medical attention after being discharged from the hospital.

Still further, the technology offers patients who are in a coma or at the point where medical treatment can no longer extend their life an alternative to staying at a hospital. Using the systems and methods described herein, a nurse can monitor the situation with loved ones present or with the support of a skilled nurse who visits the home on a periodic basis. A similar need arises, and is met by the systems and methods of the present invention, with regard to specialized care that is not available in rural areas separated by distance from major metro areas.

Individuals or families of individuals could be scored based on their health status and this health score could be shared with other entities or the health plan, rating them for future renewals or policy adjustments as time goes on. The score could be based on a nationwide comparison to others. Individuals could see their medical insurance rates drop as their health scores increase and maintain optimal levels.

Also, as a result of the targeted information that is received, a smaller number of healthcare staff members are required in connection with monitoring the individuals. Health care professionals can communicate with the individual when adverse conditions are detected. Also, health care staff can concentrate on individuals who are at higher risk and message those individuals reminders regarding medication they need to take or if they are following their prescribed therapy.

Still further, individuals may want to share their visual representations with others, interacting with others in an on-line community who share their same conditions or want to learn about how others cope with any issue or problem they may have. This community could be comprised of virtual homes and people exchanging information or sharing stories about their lifelong health status.

What is claimed is:

1. A system comprising:
memory operable to store at least one program; and
at least one processor communicatively coupled to the memory, in which the at least one program, when executed by the at least one processor, causes the at least one processor to:
receive data describing one or both of a physical and mental status of an individual;
create a visual representation of the status;
display the visual representation to a representative of the individual;
receive data describing an interaction of the representative with the visual representation;
receive feedback data regarding the visual representation from the representative; and
communicate the feedback data to the individual.

2. The system of claim 1 wherein the processor is further caused to:
display the visual representation to the individual.

3. A non-transitory computer-readable storage medium that stores instructions which, when executed by one or more processors, cause the one or more processors to perform a method comprising:
receiving data describing one or both of a physical and mental status of an individual;
creating a visual representation of the status;
displaying the visual representation to a representative of the individual;
receiving data describing an interaction of the representative with the visual representation;
receiving feedback data regarding the visual representation from the representative; and
communicating the feedback data to the individual.

4. The non-transitory computer-readable storage medium of claim 3 wherein the method further comprises:
displaying the visual representation to the individual.

5. A computer-implemented method, comprising:
receiving data describing one or both of a physical and mental status of an individual;
creating a visual representation of the status;
displaying the visual representation to a representative of the individual;
receiving data describing an interaction of the representative with the visual representation;
receiving feedback data regarding the visual representation from the representative; and
communicating the feedback data to the individual.

6. The method of claim 5 further comprising:
displaying the visual representation to the individual.
